(19) United States
(12) Patent Application Publication
(10) Pub. No.: US 2015/0006616 A1
(43) Pub. Date: Jan. 1, 2015

(54) Host Offloading Architecture

(71) Applicant: Broadcom Corporation, Irvine, CA (US)

(72) Inventors: John WALLEY, Ladera Ranch, CA (US); Frank van DIGGELEN, San Jose, CA (US)

(21) Appl. No.: 13/931,703

(22) Filed: Jun. 28, 2013

(51) Int. Cl. H04L 29/08

(52) U.S. Cl. CPC H04L 67/16
USPC 709/203

(57) ABSTRACT

A communication platform that integrates communication and sensing capabilities into a single integrated communication platform. The communication platform can senses relativity information, such as environmental information, location information, platform user information, or the like. Further, the communication platform can perform cross-sensor functionality so as to utilize relativity information from multiple sensors. The cross-sensor functionality can be utilized in multiples sensors implemented within the communication platform, in one or more other communication platforms, or any combination thereof. The communication platform can also offload processing operations from a host processor to one or more sensor hubs and/or sensor processors within the communication platform and/or to a sensor processor of one or more other communication platforms. Similarly, the communication platform can also offload sensing operations by requesting relativity from one or more sensors of one or more other communication platforms.

### CROSS REFERENCE TO RELATED APPLICATIONS

This patent application relates to U.S. patent application Ser. No. ______ (Attorney Reference No. 3875.7230000) filed on the same day as the present application, entitled “Device Relativity Architecture,” which is incorporated herein by reference in its entirety.

### FIELD

This application relates generally to communication platforms, and more particularly to communication platforms that include communication and sensing capabilities.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIGS. 1A-B illustrate communication platforms in accordance with exemplary embodiments of the present disclosure.

FIGS. 2A-F illustrate communication platforms in accordance with exemplary embodiments of the present disclosure.

FIG. 3 illustrates a communication platform in accordance with exemplary embodiments of the present disclosure.

The embodiments of the present disclosure will be described with reference to the accompanying drawings. The drawing in which an element first appears is typically indicated by the leftmost digit(s) in the corresponding reference number. Further, reference numbers that include rightmost alphabetic characters or subscripted numerals typically indicate two or more similar elements that share common features.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

For purposes of this discussion, the term “module” shall be understood to include at least one of software, firmware, and hardware (such as one or more circuits, microchips, processors, or devices, or any combination thereof), and any combination thereof. In addition, it will be understood that each module may include one or more components within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired and/or wireless manner.

### Exemplary Communication Device

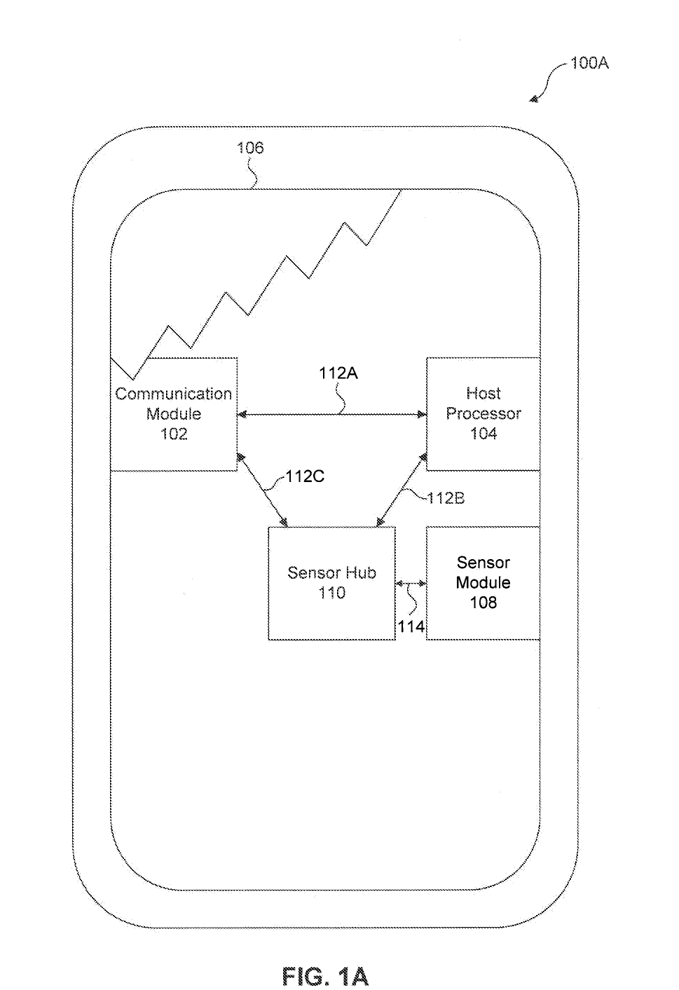

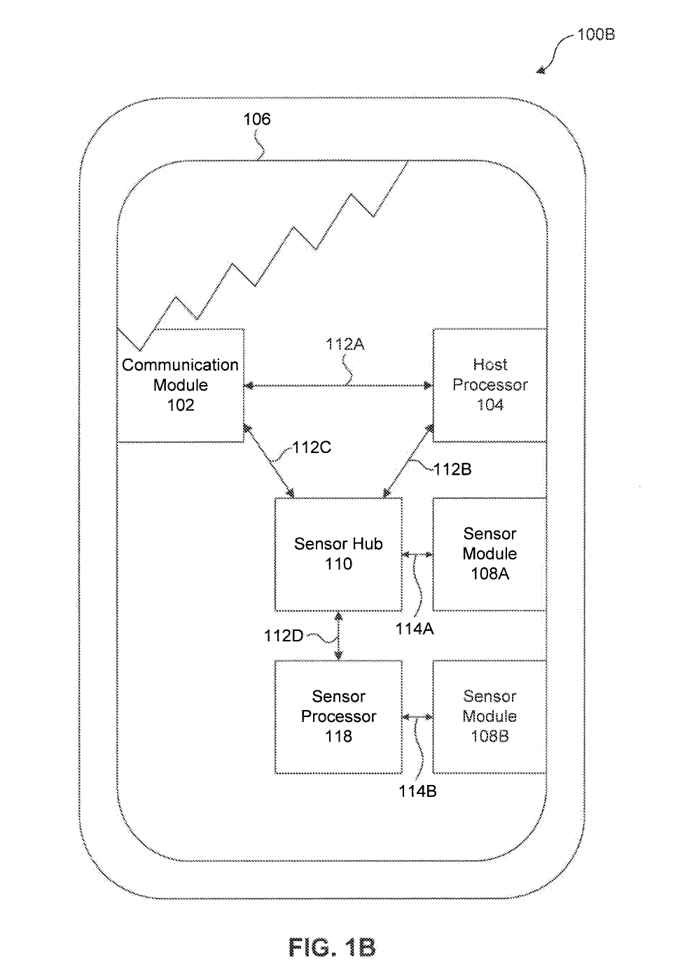

FIG. 1A illustrates a block diagram of a communication platform according to an exemplary embodiment of the present disclosure. An exemplary communication platform 100A integrates communication and sensing capabilities into a single integrated communication platform. The communication platform 100A communicates information, such as audio data, video data, image data, command data, control data and/or other data to provide some examples, between a near-end user and a far-end user over various wired and/or wireless communication networks. The exemplary communication platform 100A can represent a mobile communication device, such as a cellular phone or a smartphone, a motile computing device, such as a tablet computer or a laptop computer, or any other electronic device that is capable of communicating information that will be apparent to those skilled in the relevant art(s) without departing from the spirit and scope of the present disclosure. Additionally, the exemplary communication platform 100A senses relativity information, such as environmental information, location information, and/or platform user information to provide some examples. For the purposes of this discussion, relativity information can include, for example, one or more of: information corresponding to the operation and/or condition of a communication platform, internal and/or external environmental information of the communication platform, information corresponding to one or more users of the communication platform, information associated with one or more external stimuli affecting the communication platform, and/or any other information associated with the communication platform as will be apparent to those of ordinary skill in the relevant art(s).

The exemplary communication platform 100A includes a communication module 102, a host processor 104, a display 106, a sensor module 108, a sensor hub 110, communication interfaces 112A-C, and a dedicated communication interface 114. It should be appreciated by those skilled in the relevant art(s) that the exemplary communication platform 100A can include one or more sensor hubs 110, where each of the sensor hubs 110 can include one or more sensor modules 108. In an exemplary embodiment, communication interface 112A communicatively couples the communication module 102 with the host processor 104, the communication interface 112B communicatively couples the host processor 104 with the sensor hub 110, and the communication interface 112C communicatively couples the sensor hub 110 with the communication module 102. The dedicated communication interface 114 communicatively couples the sensor hub 110 with the sensor module 108.

The communication module 102 includes suitable logic, circuitry, and/or code that is configured to communicate information, such as audio data, video data, image data, command data, control data and/or other data to provide some examples, between a near-end user and a far-end user over various wired and/or wireless communication networks. The communication module 102 can include a Bluetooth module, a Global Navigation Satellite System (GNSS) module, a cellular module, a wireless local area network (WLAN) module, a near field communication (NFC) module, a radio frequency identification (RFID) module, infrared (IR) module, and/or a wireless power transfer (WPT) module. The Bluetooth module, the cellular module, the WLAN module, the NFC module, the RFID module, and the IR module provide wireless communication between the exemplary communication platform 100A and other Bluetooth, other cellular, other WLAN, other NFC, other RFID, and other IR capable communication devices, respectively, in accordance with various communication standards or protocols. These various communication standards or protocols can include various cellular communication standards such as a third Generation Partnership Project (3GPP) Long Term Evolution (LTE) communications standard, a fourth generation (4G) mobile communications standard, or a third generation (3G) mobile communications standard, various networking protocols such a Worldwide Interoperability for Microwave Access (WiMAX) communications standard or a Wi-H communications standard, various NFC/RFID communications protocols such as ISO 1422, ISO/IEC 14443, ISO/IEC 15693, ISO/IEC 18000, or FeliCa to provide some examples. The GNSS module receives various signals from various satellites to determine location information for the exemplary communication platform 100A. The WPT module supports wireless transmission of power between the exemplary communication platform 100A and another WPT capable communication device. Each of the above communication standards and protocols is incorporated herein by reference in its entirety. Further, the communication platform 100A can include an antenna or multiple antennas forming an antenna array that is communicatively coupled to the communication module 102.

The host processor 104 includes suitable logic, circuitry, and/or code that is configured to control overall operation and/or configuration of the exemplary communication platform 100A. The host processor 104 can receive and/or process information from a user interface such as an alphanumeric keypad, a microphone, a mouse, a speaker, and/or from other electrical devices or host devices that are coupled to the exemplary communication platform 100A. The host processor 104 can provide this information to the communication module 102 and/or the sensor hub 110. Additionally, the host processor 104 can receive and/or process information from the communication module 102 and/or the sensor hub 110. The host processor 104 can provide this information to the user interface, to other electrical devices or host devices, and/or to the communication module 102 and/or the sensor hub 110. Further, the host processor 104 can execute one or more applications such as Short Message Service (SMS) for text messaging, electronic mailing, and/or audio and/or video recording to provide some examples, and/or software applications such as a calendar and/or a phone book to provide some examples.

The display 106 represents an electronic visual display that can detect a presence and/or a location of a touch that is proximate to its display area. The display 106 includes a display area to provide information from the sensor hub 110 to the near-end user. Additionally, the display 106 includes one or more integrated imaging elements that are integrated within and/or approximate to the display area to provide information from the near-end user to the sensor hub 110. The one or more integrated imaging elements are configured and arranged to detect a presence and/or a location of a touch from the near-end user. The touch can represent a physical touching of the display area by the near-end user and/or by other passive objects available to the near-end user, such as a stylus to provide an example, and/or proximity of the near-end user and/or the other passive objects to the display area.

The sensor module 108 includes suitable logic, circuitry, and/or code that is configured to provide relativity information to the sensor hub 110. The relativity information can represent analog relativity information, such as a voltage and/or current to provide some examples, or digital relativity information, such as a sequence of digital logic values, referred to as bits, to provide an example. The relativity information can include environmental information, location information, and/or platform user information to provide some examples. The environmental information can include humidity, precipitation, temperature, wind speed, atmospheric pressure, ambient light, ambient noise, or any other environmental condition. The location information can include orientation, compass coordinates such as longitude and/or latitude, azimuth, altitude, pitch, roll, yaw, to provide some examples, velocity, acceleration, time, weight, mass and/or any other location information to provide some examples. The platform user information can include user heart rate, user blood glucose levels, user blood pressure levels, user body temperature, and/or any user information to provide some examples.

The sensor module 108 includes one or more sensors to sense the relativity information. The one or more sensors can include one or more humidity sensors, one or more precipitation sensors, one or more thermometers, one or more anemometers, one or more barometers, one or more ambient light sensors, such as one or more photodetectors, one or more ambient noise sensors, such as one or more microphones, one or more compasses, one or more accelerometers, one or more gyroscopes, one or more magnetometers, one or more heart rate monitors, one or more blood glucose meters, one or more sphygmomanometers, and/or any other suitable sensors that are capable of providing relativity information that will be apparent to those skilled in the relevant art(s).

In a conventional communication platform, a host controller conventionally controls overall operation and/or configuration of sensors in the conventional communication platform. However, in the exemplary communication platform 100A, the overall operation and/or configuration of the one or more sensors within the communication platform are offloaded to the sensor hub 110. This allows host processor 104 to be in a sleep state more often, thereby reducing power consumption.

The sensor hub 110 includes suitable logic, circuitry, and/or code that is configured to control the operation and/or configuration of the sensor module 108, to provide an interface to the sensor module 108, and to perform processing on relative information received from the sensor module 108. This processing can include pre-processing of the relative information before supplying the information to the host processor 104 for further processing, as well as more computational intensive processing operations generally performed by the host processor 104 in embodiments where the sensor hub 110 performs pre-processing operations. In an exemplary embodiment, the sensor hub 110 is lower-powered device in comparison to the host processor 104. That is, by offloading operational control and/or processing from the host processor 104 to the sensor module 110, power consumption of the communication platform 100A can be reduced.

The sensor hub 110 represents an interface between the communication module 102, the host processor 104, the display 106, and/or the sensor module 108 to route information between these modules. Typically, the sensor hub 110 receives a request for relativity information from the communication module 102, the host processor 104, and/or the display 106. The request for relativity information often includes one or more instructions to query the sensor module 108 for corresponding relativity information. In some situations, the one or more instructions can include one or more commands that are selected from a common set of commands that is shared by and available to the communication module 102, the host processor 104, and the display 106 for accessing the corresponding relativity information and associated identifiers indicating a recipient of the corresponding relativity information. For example, the host processor 104 can select a corresponding command from the common set of commands to request temperature information from the sensor module 110. In this example, the host processor 104 attaches a header having an identifier, as well as other information, to the corresponding command to form the request for relativity information. In this example, the host processor 104 thereafter provides the request for relativity information to the sensor hub 110. Also, in this example, the communication module 102 and/or the display 106 can also select the corresponding command from the common set of commands when requesting the temperature information; however, the communication module 102 and/or the display 106 can attach corresponding headers having corresponding identifiers to the corresponding command to form corresponding requests for relativity information.

Thereafter, the sensor hub 110 executes the one or more instructions within the request for relativity information to query the sensor module 108 for the relativity information associated with the one or more instructions. This querying can include sampling of the relativity information that is continuously, or substantially continuously, provided by the sensor module 108. This querying can additionally include activating one or more sensors within the sensor module 108 to provide the relativity information associated with the one or more instructions. In some situations, the sensor huh 110 can directly query the sensor module 108 for the relativity information at predetermined instances in time. For example, the one or more instructions can cause the sensor hub 110 to query the sensor module 108 for the relativity information at a given instance in time and can cause the sensor hub 110 to query the sensor module 108 at future instances in time for the relativity information.

In an exemplary embodiment, the sensor hub 110 can pre-process the relativity information before providing the relativity information to the communication module 102, the host processor 104, and the display 106. Typically, the sensor hub 110 can load and/or execute one or more pre-processing functions that are stored within a memory that is accessible with the sensor hub 110. These pre-processing functions can include interrupt handling, polling, sampling, decimating, interpolating, algorithmic processing, auto-calibration, stabilizing, time-stamping, compressing, and/or formatting to provide some examples. For example, the sensor hub 110 can format the relativity information into a format that is suitable for use by the communication module 102, the host processor 104, and/or the display 106. This is most commonly achieved by converting the relativity information from a representation in an analog signal domain to a representation in a digital signal domain and, optionally, packetizing the digital signal domain representation of the relativity information into data packets for transport to the communication module 102, the host processor 104, and/or the display 106.

The sensor hub 110 can also be configured to process the relative information independent of the host processor 104 by performing computational intensive processing operations generally performed by the host processor 104. That is, the sensor hub 110 can be configured to control the operation and/or configuration of the sensor module 108 independent of the host processor 104. Here, the sensor hub 110 can be configured to provide the processed information in response to requests for such information by the communication module 102, the host processor 104, and/or the display 106. The sensor hub 106 can also be configured to provide the information to the communication module 102, the host processor 104, and/or the display 106 notwithstanding a request for such information. That is, the sensor hub 110 can be configured to provide the information to the communication module 102, the host processor 104, and/or the display 106 if the sensor hub 110 determines that such processed information would be useful information and/or is necessary for the overall control and operation of the communication platform 100A. For example, if through pre-processing and/or processing of relativity information by the sensor hub 110, it is determined that the communication platform 100A is abruptly accelerating and/or moving, which could indicate that the communication platform 100A has been dropped, the sensor hub 110 could provide the relativity information indicative of this possible scenario to the host processor 104. If the host processor 104 is in a sleep cycle or otherwise occupied, this could include an interrupt to the host processor for immediate attention. Using such information, the host processor 104 could control the communication platform 100A to perform operations to safeguard information, protect hardware, or the like. For example, the host processor 104 could safely terminate one or more currently running application, spin down a hard disk drive of the communication platform 100A, or the like.

The sensor hub 110 can also be configured to prioritize the processed information, and provide the prioritization to the communication module 102, the host processor 104, and/or the display 106. Further, the sensor hub 110 can be configured to utilize the prioritization in determining whether to provide the relativity information to one or more of the various components absent a request for such information. For example, in the example in which the information could indicate that the communication platform 100A has been dropped and/or is falling, such information could be given a high priority to indicate to the host processor 104 that immediate action should be taking.

In an exemplary embodiment, the sensor hub 110 can be configured to perform cross-sensor functionality so as to utilize relativity information from a first sensor from among the sensor module 108 to query a second sensor from the same sensor module 108 for its relativity information. Here, the cross-sensor functionality can be implemented in one or more of the pre-processing operations and/or processing operations performed by the sensor hub 110. For example, the sensor hub 110 can determine whether the exemplary communication platform 100A is in motion from location information provided by the first sensor and can query a second sensor to provide platform user information when it is determined that the exemplary communication platform 100A is moving.

Similarly, in an exemplary embodiment in which two or more sensor modules 108 are communicatively coupled to the sensor hub 110, the sensor hub 110 can be configured to perform cross-sensor functionality so as to utilize relativity information from a first sensor of a first sensor module 108 to query a second sensor of a second sensor module 108.

Further, the sensor hub 110 can be configured to issue instructions to the communication module 102, the host processor 104, and/or the display 106 based upon the relativity information. For example, the sensor hub 110 can determine whether the communication platform 100A is in motion from location information provided by the sensor module 108 and can issue an instruction to the host processor 104 to enter into an active state, referred to as a wake up, from an inactive state, also referred to as a sleep state. In another example, the sensor hub 110 can determine whether the communication platform 100A is in motion from location information provided by the sensor module 108 and can issue an instruction to the host processor 104 and/or communication module 102 to perform beam forming processing, including angle of arrival calculations, antenna switching, or the like to account for the motion and/or position of the communication platform 100A, so as to maintain or improve communications channel quality to/from another wireless device, such as a basestation. In a similar example, the sensor hub 110 can determine whether the communication platform 100A is in motion and the amount of such motion from location information provided by the sensor module 108. Based on this determination, the sensor hub 110 can issue an instruction to the host processor 104 and/or communication module 102 to rescan for available wireless network connections. For example, no rescanning is performed if it is determined that the communication platform 100A has not moved or has moved a nominal amount, for example, one foot. While the sensor hub 110 can instruct the host processor 104 and/or communication module 102 to rescan for available wireless network connections if it is determined that the communication platform 10A has moved, for example, by a larger amount such as 10 feet.

In an exemplary embodiment, the sensor hub 110 can be configured to utilize information from the communication module 102, the host processor 104, and/or the display 106 to gather relativity information associated with the communication platform 100A or vice versa. For example, the sensor hub 110 can request wireless network information from the communication module 102 (e.g., WiFi or cellular data) that can be utilized to determine the position of the communication platform 100A.

That is, the sensor hub 110 can also be configured to request information from the communication module 102, the host processor 104, and/or the display 106 based on information from one or more sensors among one or more sensor modules 108 similar to the cross-sensor functionality discussed above. For example, the sensor hub 110 can determine whether the communication platform 100A is in motion from location information provided by a sensor of the sensor module 108, and can query the communication module 102 for wireless network information to assist in the motion determination.

Similarly, the sensor hub 110 can query relativity information from one or more sensors from among one or more sensor modules 108 based on information received from the communication module 102, the host processor 104, and/or the display 106. For example, based on wireless network information received from the communication module 102, the sensor hub 110 can determine the coarse location and/or motion of the communication platform 100A. Based on this coarse determination, the sensor hub 110 can query one or more sensors (e.g., GNSS sensor) from among one or more sensor modules 108 to assist in the location and/or motion determination to provide a more accurate determination.

The communication interfaces 112A-C represents communication interfaces that communicatively couple the communications module 102, the host processor 104, and the sensor hub 110 for routing of various communications between the communications module 102, the host processor 104, and the sensor hub 110. These communications can include various digital signals, such as one or more commands and/or data to provide some examples, various analog signals, such as direct current (DC) currents and/or voltages to provide some examples, or any combination thereof. The communication interfaces 112 can be implemented as a series of wired and/or wireless interconnections between the communications module 102, the host processor 104, and the sensor hub 110. The interconnections of the communication interfaces 112 can be arranged to form a parallel interface to route communications between the communications module 102, the host processor 104, and the sensor hub 110 in parallel, a serial interface to route communications between the communications module 102, the host processor 104, and the sensor hub 110, or any combination thereof.

The dedicated communication interface 114 represents a communication interface that is accessible by the sensor module 108 and the sensor hub 110 for routing of various communications between the sensor module 108 and the sensor hub 110. These communications can include various digital signals, such as one or more commands and/or data to provide some examples, various analog signals, such as direct current (DC) currents and/or voltages to provide some examples, or any combination thereof. The dedicated communication interface 114 can be implemented as a series of wired and/or wireless interconnections between the sensor module 108 and the sensor hub 110. The interconnections of the dedicated communication interface 114 can be arranged to form a parallel interface to route communications between the sensor module 108 and the sensor hub 110 in parallel, a serial interface to route communications between the sensor module 108 and the sensor hub 110, or any combination thereof.

Exemplary Communication Device with One or More Sensor Processors

FIG. 1B illustrates a block diagram of a communication platform 100B according to an exemplary embodiment of the present disclosure. The communication platform 100B shares many common elements and features with the exemplary communication platform 100A. In particular, the communication platform 100B includes communication module 102, host processor 104, display 106, sensor hub 110, sensor module 108A, communication interfaces 112A-C, and a dedicated communication interface 114A. These common elements and features are not repeated here for brevity, and only differences between the communication platform 100B and communication platform 100A are to be discussed in further detail below.

The communication platform 100B also includes a sensor processor 118, a second sensor module 108B, communication interface 112D, and communication interface 114B. It should be appreciated that the sensor modules 108A and 108B, communication interface 112D, and communication interfaces 114A and 114B are similar to the sensor module 108, communication interfaces 112, and communication interface 114 of the communication platform 100A, respectively. It should also be appreciated that the communication platform 100B can include two or more sensor processors 118, each having one or more sensor modules 108.

The sensor processor 118 includes suitable logic, circuitry, and/or code that is configured to control the operation and/or configuration of the sensor module 108B, to provide an interface to the sensor module 108B, and to perform processing on relative information received from the sensor module 108B. This processing can include pre-processing of the relative information before supplying the information to the sensor hub 110 via communication interface 112D for further processing, as well as more computational intensive processing operations generally performed by the host processor 104. In an exemplary embodiment, the sensor processor 118 is lower-powered device in comparison to the host processor 104 and/or the sensor hub 110. That is, by offloading operational control and/or processing from the host processor 104 and/or the sensor module 110 to the sensor processor 118, power consumption of the communication platform 100B can be reduced.

The sensor processor 118 represents an interface to route information between the sensor module 108B and the communication module 102, host processor 104, display 106, sensor hub 110 and/or the sensor module 108A. Typically, the sensor processor 118 receives a request for relativity information from the sensor hub 110, communication module 102, host processor 104, and/or display 106. The request for relativity information often includes one or more instructions to query the sensor module 108B for corresponding relativity information. In some situations, the one or more instructions can include one or more commands that are selected from a common set of commands that is shared by and available to the communication module 102, host processor 104, display 106, and the sensor hub 110 for accessing the corresponding relativity information and associated identifiers indicating a recipient of the corresponding relativity information. For example, the host processor 104 can select a corresponding command from the common set of commands to request temperature information from the sensor processor 118. In this example, the host processor 104 attaches a header having an identifier, as well as other information, to the corresponding command to form the request for relativity information. In this example, the host processor 104 thereafter provides the request for relativity information to the sensor processor 118 via the sensor hub 110. Also, in this example, the communication module 102, display 106 and/or sensor hub 110 can also select the corresponding command from the common set of commands when requesting the temperature information; however, the communication module 102, display 106 and/or sensor hub 110 can attach corresponding headers having corresponding identifiers to the corresponding command to form corresponding requests for relativity information. The identifiers may also identify the specific target sensor module 108 from which the sensor data is requested.

Thereafter, the sensor processor 118 executes the one or more instructions within the request for relativity information to query the sensor module 108B for the relativity information associated with the one or more instructions. This querying can include sampling of the relativity information that is continuously, or substantially continuously, provided by the sensor module 108B. This querying can additionally include activating one or more sensors within the sensor module 108B to provide the relativity information associated with the one or more instructions. In some situations, the sensor processor 118 can directly query the sensor module 108B for the relativity information at predetermined instances in time. For example, the one or more instructions can cause the sensor processor 118 to query the sensor module 108B for the relativity information at a given instance in time and can cause the sensor processor 118 to query the sensor module 108B at future instances in time for the relativity information.

In an exemplary embodiment, the sensor hub 110 of the communication platform 100B can include suitable logic, circuitry, and/or code that is configured to manage and control the operation and/or configuration of one or more sensor processors 118. For example, the sensor hub 110 can be configured to request relativity information from a sensor processor 118 by providing the sensor processor 118 with one or more instructions to query the sensor module 108B for corresponding relativity information. Further, as discussed in more detail below, the request for relativity information by the sensor hub 110 can be performed independent of the host processor 104 thereby offloading operational control and/or processing from the host processor 104.

In an exemplary embodiment, the sensor processor 118 can pre-process the relativity information before providing the relativity information to the sensor hub 110, communication module 102, host processor 104, and display 106. Typically, the sensor processor 118 can load and/or execute one or more pre-processing functions that are stored within a memory that is accessible with the sensor processor 118. These pre-processing functions can include interrupt handling, polling, sampling, decimating, interpolating, algorithmic processing, auto-calibration, stabilizing, time-stamping, compressing, and/or formatting to provide some examples. For example, the sensor processor 118 can format the relativity information into a format that is suitable for use by the, sensor hub 110, communication module 102, host processor 104, and/or display 106. This is most commonly achieved by converting the relativity information from a representation in an analog signal domain to a representation in a digital signal domain and, optionally, packetizing the digital signal domain representation of the relativity information into data packets for transport to the sensor hub 110, communication module 102, host processor 104, and/or display 106.

The sensor processor 118 can also be configured to process the relative information independent of the host processor 104 and/or sensor hub 110 by performing processing operations generally performed by the host processor 104 and/or sensor hub 110. That is, the sensor processor 118 can be configured to control the operation and/or configuration of the sensor module 108B independent of the host processor 104 and/or sensor hub 110. Here, the sensor processor 118 can be configured to provide the processed information in response to requests for such information by the sensor hub 110, communication module 102, host processor 104, and/or the display 106.

In an exemplary embodiment, the sensor processor 118 can be configured to perform cross-sensor functionality so as to utilize relativity information from a first sensor from among the sensor module 108B to query a second sensor from the sensor module 108B for its relativity information. Here, the cross-sensor functionality can be implemented in one or more of the pre-processing operations and/or processing operations performed by the sensor processor 118. For example, the sensor processor 118 can determine whether the exemplary communication platform 100B is in motion from location information provided by the first sensor and can query a second sensor to provide platform user information when it is determined that the exemplary communication platform 100B is moving. Further, the sensor processor 118 can be configured to issue instructions to the sensor hub 110, communication module 102, host processor 104, and/or display 106 based upon the relativity information. For example, the sensor processor 118 can determine whether the exemplary communication platform 100B is in motion from location information provided by the sensor module 108B and can issue an instruction to the host processor 104 to enter into an active state, referred to as a wake up, from an inactive state, also referred to as a sleep state.

In an exemplary embodiment in which two or more sensor modules 108 are communicatively coupled to the sensor processor 118, the sensor processor 118 can be configured to perform cross-sensor functionality so as to utilize relativity information from a first sensor of a first sensor module 108 to query a second sensor of a second sensor module 108. Similarly, in an exemplary embodiment in which two or more sensor processors 118 are communicatively coupled to the sensor hub 110, the sensor hub 110 can be configured to perform cross-sensor functionality by managing and/or controlling the sensor processors 118 to utilize relativity information from a first sensor of a first sensor module 108 via a first sensor processor 118 to query a second sensor of a second sensor module 108 via a second sensor processor 118.

In an exemplary embodiment, the sensor processor 118 and the one or more corresponding sensor modules 108 can be implemented on the same or different integrated circuit within the communication platform 100B. For example, the sensor processor 118 and corresponding sensor module 108B can be implemented on the same integrated circuit on which the communication module 102, host processor 104 and sensor hub 110 have been implemented. Alternatively, the communication module 102, host processor 104 and sensor hub 110 can be implemented on a first integrated circuit, and the sensor processor 118 and corresponding sensor module 108B can be implemented on a second integrated circuit that is different from the first integrated circuit. That is, although FIG. 1B shows these components within the communication platform 10013, the components can be implemented on two or more different integrated circuits. Further, it should be appreciated that the various components of the communication platform 100B can be implemented in various combinations of different integrated circuits within the communication platform 100B. For example, the communication module 102, host processor 104, sensor huh 110, and sensor processor 118 can be implemented on a first integrated circuit while the sensor modules 108A and 108B can be implemented on a second integrated circuit. The use of multiple integrated circuits enables different manufacturing processes to be used for the different integrated circuits, that can provide performance and power usage advantages for the different functions,

Exemplary Communication Device with Two or More Communication Platforms

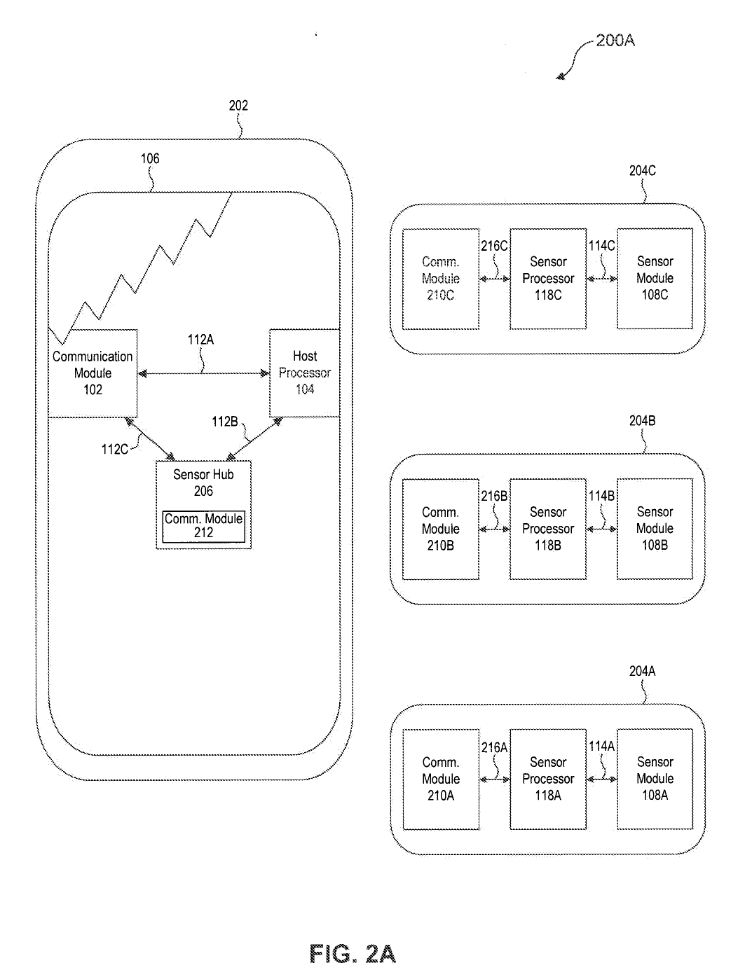

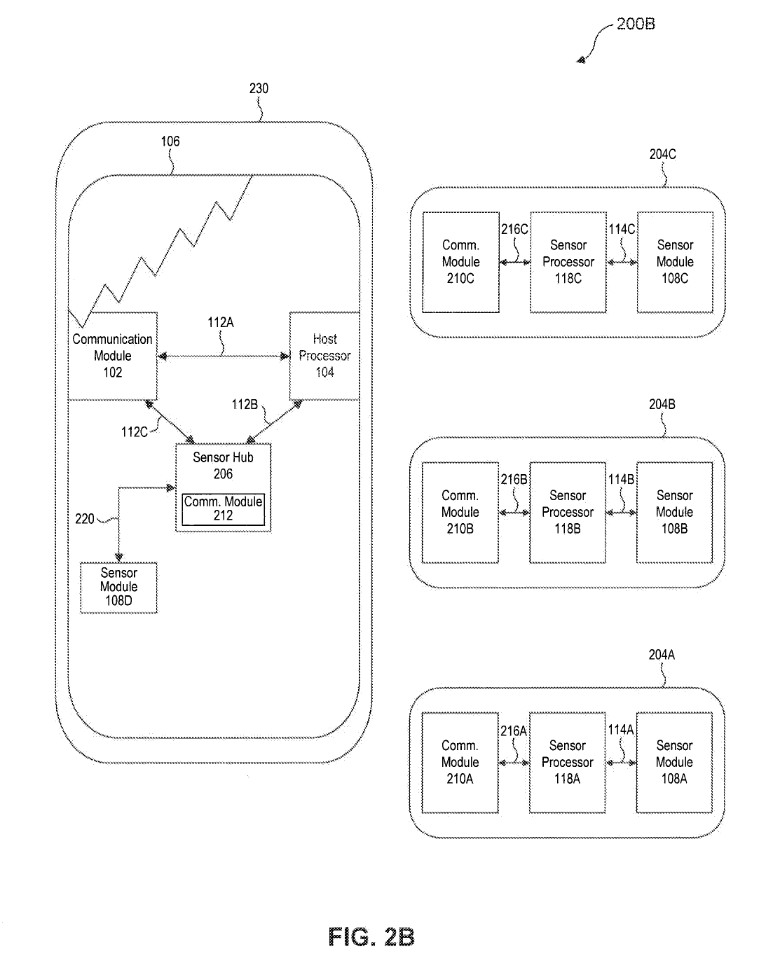

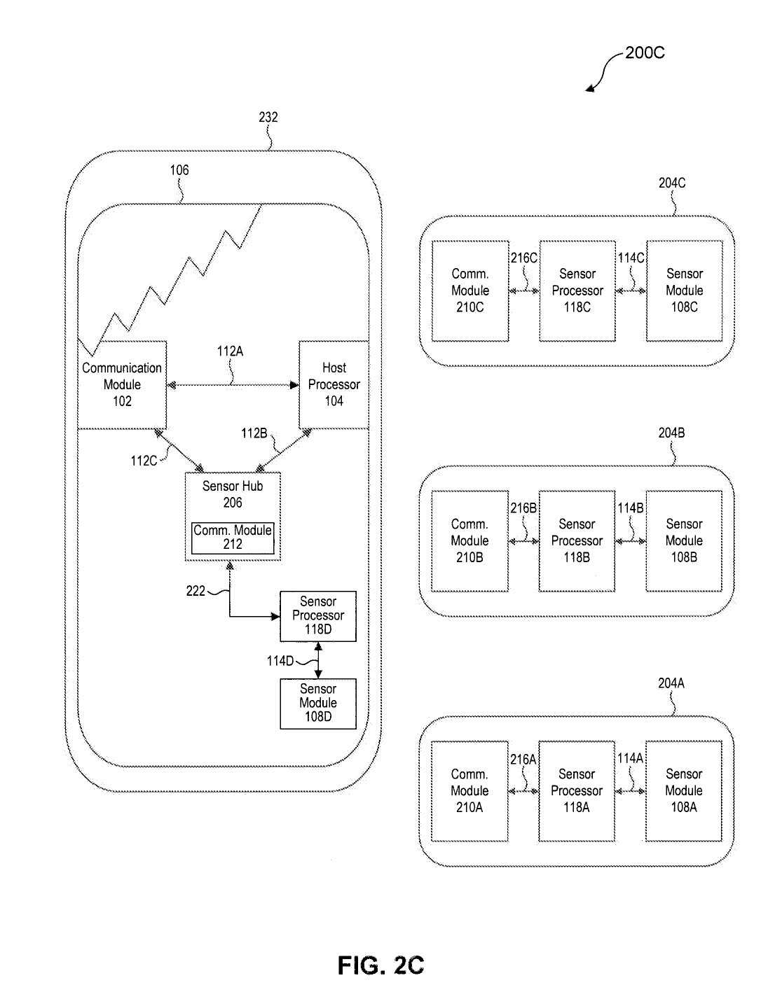

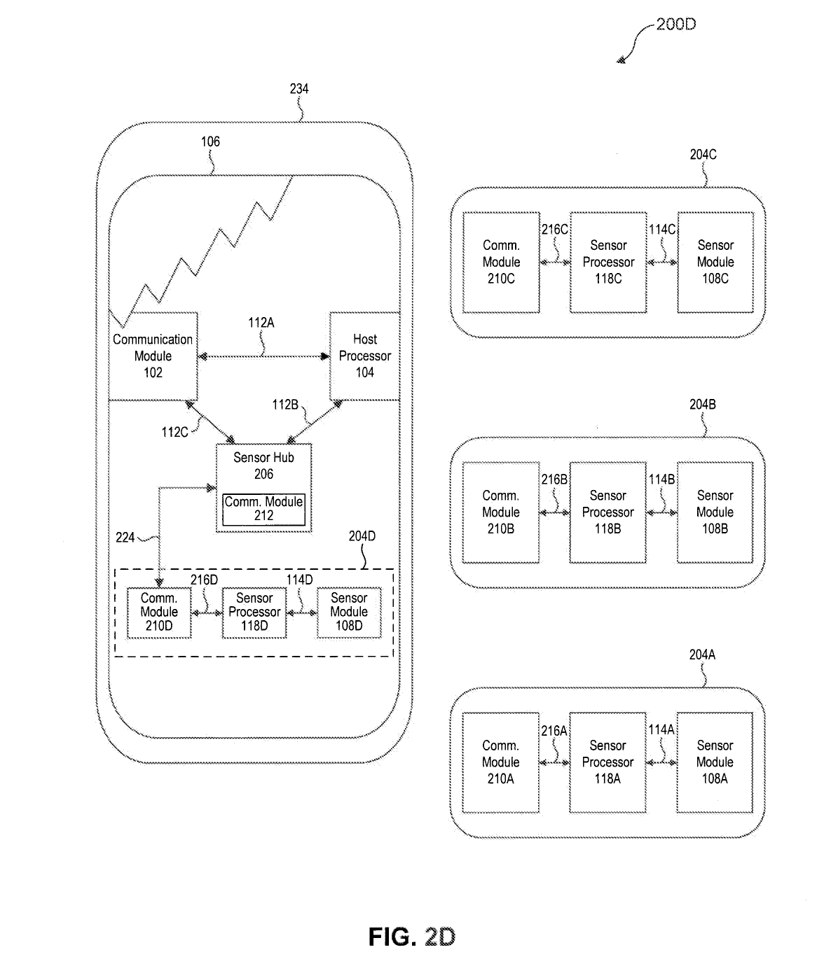

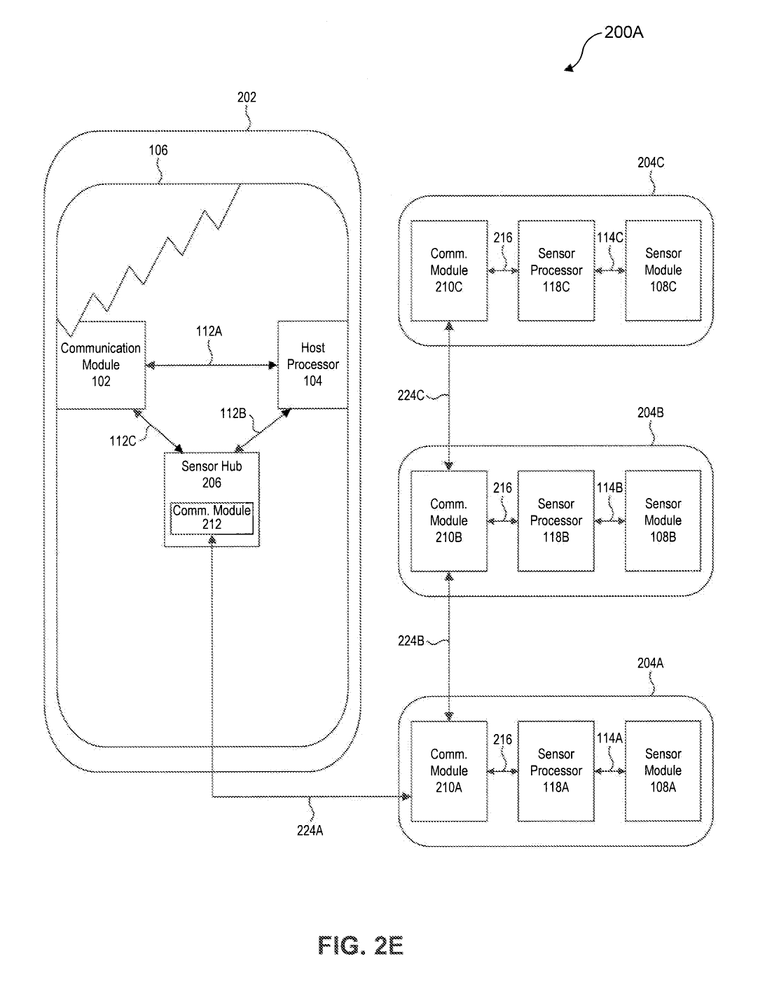

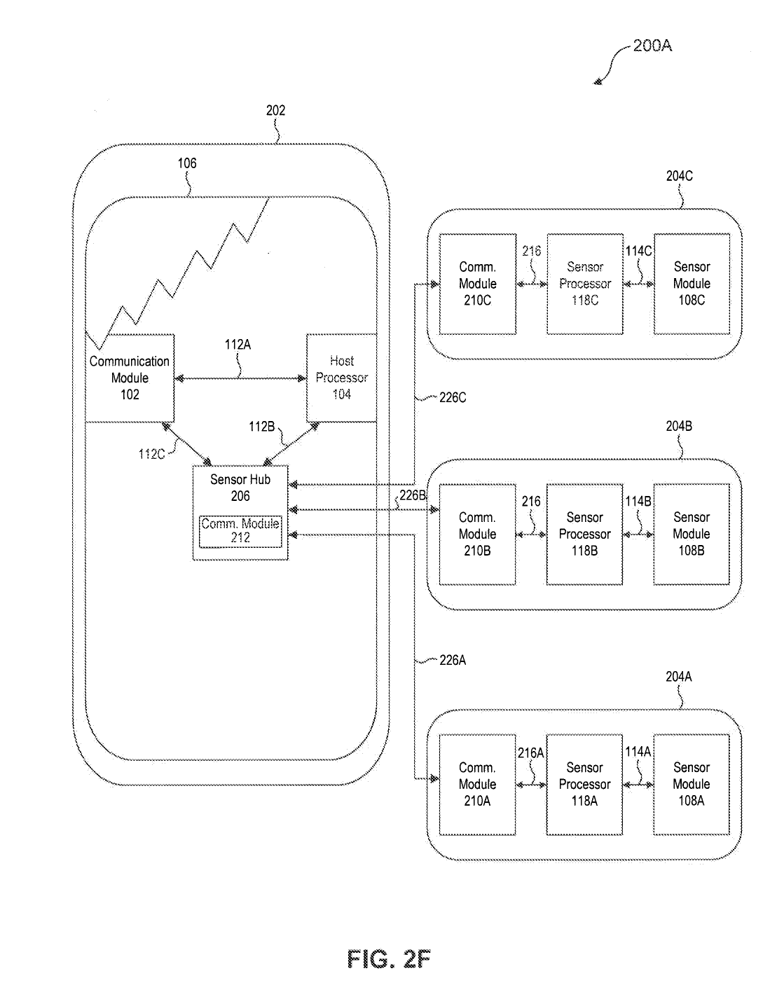

FIGS. 2A-2F illustrate block diagrams of various exemplary embodiments of communication devices that include two or more communication platforms that are configured to integrate communication and sensing capabilities with one another.

FIG. 2A illustrates a block diagram of a communication platform 200A according to an exemplary embodiment of the present disclosure. Communication platform 200A integrates communication and sensing capabilities across multiple integrated communication platforms. The exemplary communication platform 200A includes a first communication platform 202 that is integrated and communicates with one or more other communication platforms 204. Although FIGS. 2A-2F illustrate three communication platforms 204A-C, one of ordinary skill in the relevant art(s) would understand that the various embodiments should not be limited to the three exemplary communication platforms 204, and the various exemplary embodiments can include fewer or greater quantity of communication platforms 204.

The communication platform 202 communicates the information between the near-end user and the far-end user over various wired and/or wireless communication networks. The communication platform 202 can represent a mobile communication device, such as a cellular phone or a smartphone, a mobile computing device, such as a tablet computer or a laptop computer, or any other electronic device that is capable of communicating information that will be apparent to those skilled in the relevant art(s) without departing from the spirit and scope of the present disclosure.

Each of the communication platforms 204 can represent an electronic, a mechanical, and/or an electromechanical device that is communicatively coupled to the first communication platform 202. The communication platform 204 can represent a mobile communication device, such as a cellular phone or a smartphone, a mobile computing device, such as a tablet computer or a laptop computer, a mobile sensing device having one or more sensors and communication modules, such as a mobile GNSS sensor, one or more sensors, processors, and/or communication modules integrated within a vehicle, aircraft, boat, or the like, or any other electronic device that is capable of communicating information that will be apparent to those skilled in the relevant art(s) without departing from the spirit and scope of the present disclosure.

The communication platforms 204 can be configured to be plugged into the communication platform 202 via a wired connection, and/or in wireless communication with the communication platform 204 via one or more well-known wireless communication protocols. The communication platforms 204 include sensors configured to sense relativity information, such as environmental information, location information, operational information of a connected device, and/or platform user information to provide some examples.

The communication platforms 202 and 204 share many common elements and features with each other and with the exemplary communication platforms 100A and 100B of FIGS. 1A and 1B, respectively. In particular, the communication platform 202 includes communication module 102, host processor 104, display 106, and communication interfaces 112A-C. Further, communication platforms 204A-C each include a sensor processor 118 and sensor module 108. Some or all of the description of these elements and features have been described above and therefore are not repeated here for brevity.

The communication platform 202 also includes a sensor hub 206 communicatively coupled to the host processor 104 and communication module 102 via communication interfaces 112B and 112C, respectively. The sensor hub 206 shares many common elements and features with the sensor hub 110 of FIGS. 1A and 1B, and includes a communication module 212. As discussed in more detail below, each of the communication platforms 204 also include a communication module 210, which is communicatively coupled to a respective sensor processor 118 via communication interface 216. The sensor processor 118 is further communicatively coupled to a respective sensor module 108 via communication interface 114.

The communication interface 216 is similar to the communication interface 114, and routes various communications between the communication module 210 and the sensor processor 118, while the communication interface 114 routes various communications between the sensor processor 118 and the sensor module 108. These communications can include various digital signals, such as one or more commands and/or data to provide some examples, various analog signals, such as direct current (DC) currents and/or voltages to provide some examples, or any combination thereof. For example, the digital or analog data can represent sensor data determined by the corresponding sensor. The communication interface 216 can be implemented as a series of wired and/or wireless interconnections between the communication module 210 and the sensor processor 118. The interconnections of the communication interface 216 can be arranged to form a parallel interface to route communications between the communication module 210 and the sensor processor 118 in parallel, a serial interface to route communications between the communication module 210 and the sensor processor 118, or any combination thereof.

The sensor hub 206 includes suitable logic, circuitry, and/or code that is configured to control and/or manage the operation and/or configuration of one or more communication platforms 204 that are communicatively coupled to the communication platform 202 via a communication module 212 of the sensor hub 206 and/or communication module 102. As discussed in more detail below, the one or more communication platforms 204 can be communicatively coupled to the communication platform 202 via one or more wired and/or wireless interconnections. For the purpose of this discussion, the one or more communication platforms 204 are wirelessly coupled to the sensor hub 206 via the communication module 212 and/or communication module 102.

The communication module 212 of the sensor hub 206 and the communication modules 210 of each of the communication platforms 204 include suitable logic, circuitry, and/or code that is configured to communicate information, such as audio data, video data, image data, command data, control data and/or other data to provide some examples, between the sensor hub 206 and the one or more communication platforms 204 over various wired and/or wireless communication networks. The communication modules 210 are also configured to communicate information between the communication module 102 and respective communication platforms 204. Similar to the communication module 102, the communication modules 210 and 212 can include a Bluetooth module, a Global Navigation Satellite System (GNSS) module, a cellular module, a wireless local area network (WLAN) module, a near field communication (NFC) module, a radio frequency identification (RED) module, infrared (IR) module, and/or a wireless power transfer (WPT) module. The Bluetooth module, the cellular module, the WLAN module, the NFC module, the REID module, and the IR module provide wireless communication between the exemplary communication platform 100A and other Bluetooth, other cellular, other WLAN, other NFC, other RFID, and other IR capable communication devices, respectively, in accordance with various communication standards or protocols, including, for example, various cellular communication standards such as a third Generation Partnership Project (3GPP) Long Term Evolution (LTE) communications standard, a fourth generation (4G) mobile communications standard, or a third generation (3G) mobile communications standard, various networking protocols such a Worldwide Interoperability for Microwave Access (WiMAX) communications standard or a Wi-Fi communications standard, various NEC/REID communications protocols such as ISO 1422, ISO/IEC 14443, ISO/MC 15693, ISO/IEC 18000, or FeliCa. The GNSS module receives various signals from various satellites to determine location information for the sensor hub 206. The WPT module supports wireless transmission of power between the sensor hub and another WPT capable communication device.

The sensor hub 206 is also configured to provide an interface to the one or more communication platforms 204, and to perform processing on relative information received from the one or more communication platforms 204. This processing can include pre-processing of the relative information before supplying the information to the host processor 104 for further processing, as well as more computational intensive processing operations generally performed by the host processor 104 in embodiments where the sensor hub 206 performs pre-processing operations. In an exemplary embodiment, the sensor hub 206 is lower-powered device in comparison to the host processor 104. That is, by offloading operational control and/or processing from the host processor 104 to the sensor hub 206, power consumption of the communication platform 100A can be reduced.

Similarly, in an exemplary embodiment, the sensor processors 118 are lower-powered devices in comparison with the sensor hub 206. Therefore, as discussed in more detail below, the sensor hub 206 can further offload operational control and/or processing from the sensor hub 206 to one or more of the sensor processors 118 to further reduce power consumption of the communication platform 202. Further, in embodiments with two or more sensor processors 118, the sensor processors can have similar or different (e.g., progressively decreasing) operational power levels.

The communication platform 202 and the communication platforms 204 can be configured to share a single power source. Alternatively, one or more of the communication platform 202 and the communication platforms 204 can have their own dedicated power source, and the remainder can share a power source. Therefore, in embodiments in which the communication platform 202 includes a power source different from one or more of the communication platforms 204, the offloading of operational control and/or processing to the one or more communication platforms 204 reduces the power consumption of the communication platform 202 notwithstanding the operational power level of the communication platform 202 and/or the extent of the computational operations.

The sensor hub 206 represents an interface to route information between the communication module 102, the host processor 104, the display 106, and/or the one or more communication platforms 204. Typically, the sensor hub 206 receives a request for relativity information from the communication module 102, the host processor 104, and/or the display 106. The request for relativity information often includes one or more instructions to query the sensor module 108 of one or more communication platforms 204 for corresponding relativity information. In some situations, the one or more instructions can include one or more commands that are selected from a common set of commands that is shared by and available to the communication module 102, the host processor 104, and the display 106 for accessing the corresponding relativity information and associated identifiers indicating a recipient of the corresponding relativity information. For example, the host processor 104 can select a corresponding command from the common set of commands to request temperature information from one or more of the sensor modules 108. In this example, the host processor 104 attaches a header having an identifier, as well as other information, to the corresponding command to form the request for relativity information. In this example, the host processor 104 thereafter provides the request for relativity information to the sensor hub 206. The request is thereafter provided to one or more sensor processors 118 associated with one or more corresponding sensor modules 108 via the communication module 212 of the sensor hub 206 and the communication module 210 of the corresponding communication platform 204. Also, in this example, the communication module 102 and/or the display 106 can also select the corresponding command from the common set of commands when requesting the temperature information; however, the communication module 102 and/or the display 106 can attach corresponding headers having corresponding identifiers to the corresponding command to form corresponding requests for relativity information. Further, the communication module 102 can directly communicate with the communication modules 210 to request relativity information directly from a corresponding communication platform 204.

Thereafter, one or more sensor processors 118 execute the one or more instructions within the request for relativity information to query the one or more sensor modules 108 of a corresponding one or more communication platforms 204 for the relativity information associated with the one or more instructions. This querying can include sampling of the relativity information that is continuously, or substantially continuously, provided by the sensor modules 108. This querying can additionally include activating one or more sensors within the sensor modules 108 to provide the relativity information associated with the one or more instructions. In some situations, the sensor processor 118 can directly query a corresponding sensor module 108 for the relativity information at predetermined instances in time. For example, the one or more instructions can cause the sensor processor 118 to query the sensor module 108 for the relativity information at a given instance in time and can cause the sensor processor 118 to query the sensor module 108 at future instances in time for the relativity information.

In an exemplary embodiment, the sensor hub 206 can pre-process the relativity information before providing the relativity information to the host processor 104, communication module 102, and/or display 106. Typically, the sensor hub 206 can load and/or execute one or more pre-processing functions that are stored within a memory that is accessible with the sensor processor 118. These pre-processing functions can include interrupt handling, polling, sampling, decimating, interpolating, algorithmic processing, auto-calibration, stabilizing, time-stamping, compressing, and/or formatting to provide some examples. For example, the sensor hub 206 can format the relativity information into a format that is suitable for use by the communication module 102, host processor 104, and/or display 106. This is most commonly achieved by converting the relativity information from a representation in an analog signal domain to a representation in a digital signal domain and, optionally, packetizing the digital signal domain representation of the relativity information into data packets for transport to the communication module 102, host processor 104, and/or display 106. Here, the sensor hub 206 performs pre-processing operations on relativity information from the sensor module 108 that is passed through along to the sensor hub 206 by the sensor processor 118 via the communication module 210. Further, the sensor hub 206 may be configured to analyze the relativity information, and only pass it on, or interrupt the host processor 206 if threshold values are reached. Example threshold values include temperature, location movement, and speed, among others.

Similarly, in an exemplary embodiment, the sensor processor 118 can pre-process the relativity information before providing the relativity information to the sensor hub 206 via the communication module 210, and ultimately to the host processor 104, communication module 102, and/or display 106. Typically, the sensor processor 118 can load and/or execute one or more pre-processing functions that are stored within a memory that is accessible with the sensor processor 118. These pre-processing functions can include interrupt handling, polling, sampling, decimating, interpolating, algorithmic processing, auto-calibration, stabilizing, time-stamping, compressing, and/or formatting to provide some examples. For example, the sensor processor 118 can format the relativity information into a format that is suitable for use by the sensor hub 206, communication module 102, host processor 104, and/or display 106. This is most commonly achieved by converting the relativity information from a representation in an analog signal domain to a representation in a digital signal domain and, optionally, packetizing the digital signal domain representation of the relativity information into data packets for transport to the sensor hub 206, communication module 102, host processor 104, and/or display 106. In exemplary embodiments in which the sensor processor 118 performs pre-processing operations, the sensor hub 206 may perform additional pre-processing operations and/or more computational intensive processing operations before providing the relativity information to the host processor 104. Further, the sensor processors 118 may be configured to analyze the relativity information, and only pass it on, or interrupt the host processor 206 if threshold values are reached. Example threshold values include temperature, location movement, and speed, among others.

The sensor hub 110 and/or the sensor processor 118 can also be configured to process the relative information independent of the host processor 104 by performing processing operations generally performed by the host processor 104. That is, the sensor hub 110 and/or the sensor processor 118 can be configured to control the operation and/or configuration of the sensor module 108 independent of the host processor 104. Here, the sensor hub 110 and/or sensor processor 118 can be configured to provide the processed information in response to requests for such information by the communication module 102, the host processor 104, and/or the display 106. In exemplary embodiments in which both the sensor hub 110 and the sensor processor 118 perform processing operations on the relativity information, the sensor hub 110 and sensor processor 118 can be configured to cooperatively process the information. For example, the sensor hub 206 and the sensor processor 118 can simultaneously process the information (e.g., each performing a similar processing operation on the information) or sequentially process the information (e.g., the sensor processor 118 performing a first processing operation and the sensor hub 206 performing a second processing operation following completion of the first processing operation).

In an exemplary embodiment, the sensor hub 206 and/or the sensor processors 118 can be configured to perform cross-sensor functionality so as to utilize relativity information from a first sensor from among the sensor module 108 to query a second sensor from the same sensor module 108, or from a different sensor module 108 of a different communication platform 204, for its relativity information. Here, the cross-sensor functionality can be implemented in one or more of the pre-processing operations and/or processing operations performed by the sensor hub 206 and/or sensor processors 118. For example, the sensor hub 206 can determine whether the communication platform 202 is in motion from location information provided by the first sensor of sensor module 108A via the sensor processor 118 and can query a second sensor of the sensor module 108A (or sensor module 108B via sensor processor 118B) to provide platform user information when it is determined that the communication platform 202 is moving. Further, the sensor hub 206 and/or the sensor processor 118 can be configured to issue instructions to the communication module 102, the host processor 104, and/or the display 106, based upon the relativity information. For example, the sensor hub 206 and/or the sensor processor 118 can determine whether the communication platform 202 is in motion from location information provided by the sensor module 108 and can issue an instruction to the host processor 104 to enter into an active state via an interrupt, referred to as a wake up, from an inactive state, also referred to as a sleep state. In embodiments where the sensor processor 118 issues instructions, such instructions can be communicated through the sensor hub 206 using the communication module 210-communication module 212 connection, or directly to the host processor 104 and/or the display 106 via the communication module 210-communication module 102 connection.

Similarly, in an exemplary embodiment in which two or more sensor modules 108 are communicatively coupled to a sensor processor 118, the sensor processor 118 can be configured to perform cross-sensor functionality so as to utilize relativity information from a first sensor of a first sensor module 108 to query a second sensor of a second sensor module 108. Similarly, the sensor processors 118 can be configured to perform cross-sensor functionality so as to utilize relativity information from a first sensor of a sensor module 108 of a first communication platform 204 to query a second sensor of a sensor module 108 of a second communication platform 204.

In an exemplary embodiment, the sensor hub 206 is configured to manage and/or coordinate the operation of the various communication platforms 204. For example, the sensor hub 206 can manage and/or coordinate the operational state (e.g., active/inactive) of the communication platforms 204, the frequency at which relativity information is provided to the sensor hub 206 and/or communication module 102 from the communication platforms 204, the wired and/or wireless protocols to be utilized for communication between each of the communication platforms 204, and between the communication platforms 204 and the communication platform 202, or any other operation and/or function of the various communication platforms 204 as will be apparent to those skilled in the relevant art(s).

Similarly, in an exemplary embodiment, the management and/or coordination performed by the sensor hub 206 can be partially or entirely offloaded to one or more corresponding sensor processors 118 of the various communication platforms 204. Therefore, in exemplary embodiments where the sensor hub 206 offloads management and/or coordination operations to the one or more of the sensor processors 118, power consumption of the communication platform 202 can be reduced.

Exemplary Communication Device with Two or More Communication Platforms

FIG. 2B illustrates a block diagram of a communication platform 200B according to an exemplary embodiment of the present disclosure. Communication platform 200B integrates communication and sensing capabilities across multiple integrated communication platforms. The exemplary communication platform 200B includes a first communication platform 230 that is integrated with one or more other communication platforms 204.

Communication platform 200B shares many common elements and features with communication platforms 100A, 100B, and 200A of FIGS. 1A, 1B, and 2A, respectively. Some of all of the description of these repeated elements and features are not repeated here for brevity.

Similarly to the communication platform 202 of FIG. 2A, the communication platform 230 includes communication module 102, host processor 104, display 106, communication interfaces 112A-C, sensor hub 206 (which may include communication module 212). The communication platforms 204A-C each include a communication module 210, sensor processor 118, and sensor module 108.

In an exemplary embodiment, the communication platform 230 also includes one or more sensor modules 108D communicatively coupled to the sensor hub 206 via communication interface 220. The communication interface 220 is similar to the communication interface 114, and routes various communications between the sensor hub 206 and the sensor module 108D. That is, the communication platform 230 includes one or more sensor modules 108 each having one or more sensor that are communicatively coupled to the sensor hub 206, which is also communicatively coupled via communication module 212 (e.g., wired and/or wirelessly) to one or more sensor modules 108 included in one or more corresponding communication platforms 204.

The sensor hub 206 and sensor module 108D can be similarly configured to perform the various operations and functions discussed above with respect to the sensor hub 110, sensor processor 118, and sensor modules 108. For example, the sensor hub 206 can be configured to request relativity information by querying one or more sensors of the sensor modules 108, pre-process and/or process the relativity information before providing such information to the host processor 104, communication module 102, and/or display 106, perform cross-sensor functionality with two or more sensors of the sensor module 108D, one or more sensors from one or more of the sensor modules 108A-C, or any combination thereof, and/or manage and/or coordinate the operation of the various communication platforms 204, to provide some examples. It should be appreciated that the configurations and operations of the above exemplary embodiments can also be implemented in the communication platform 200B.

Exemplary Communication Device with Two or More Communication Platforms

FIG. 2C illustrates a block diagram of a communication platform 200C according to an exemplary embodiment of the present disclosure. Communication platform 200C integrates communication and sensing capabilities across multiple integrated communication platforms. The exemplary communication platform 200C includes a first communication platform 232 that is integrated with one or more other communication platforms 204.

Communication platform 200C shares many common elements and features with communication platforms 100A, 100B, 200A, and 200B of FIGS. 1A-2B, respectively. Some or all of the description of these repeated elements and features is not repeated here for brevity.

Similarly to the communication platform 202 and 230 of FIGS. 2A and 2B, respectively, the communication platform 232 includes communication module 102, host processor 104, display 106, communication interfaces 112A-C, sensor hub 206 (which may include communication module 212). The communication platforms 204A-C each include a communication module 210, sensor processor 118, and sensor module 108.

In an exemplary embodiment, the communication platform 230 also includes one or more sensor processors 118D each coupled to one or more corresponding sensor modules 108D. Each sensor processor 118D is communicatively coupled to the sensor hub 206 via communication interface 222 and each sensor module 108D is communicatively coupled to a corresponding sensor processor 118D via communication interface 114D. The communication interface 222 is similar to the communication interface 114, and routes various communications between the sensor hub 206 and the sensor processor 118D. The sensor hub 206 can also be configured to be communicatively coupled via communication module 212 (e.g., wired and/or wirelessly) to one or more sensor modules 108 included in one or more corresponding communication platforms 204. Although not shown in FIG. 2C, the sensor module 108D can also be communicatively coupled directly to the sensor hub 206 via a communication interface 220 similar to the exemplary embodiment illustrated in FIG. 2B.

In an exemplary embodiment, the communication platform 232 also includes another sensor module that is communicatively coupled to the sensor hub 206 similarly to the configuration of the sensor module 108D illustrated in FIG. 2B. It should be appreciated that this other sensor module can be configured to implement the functions and operations of sensor module 108D of FIG. 2B as well as the various functions and operations of the above exemplary embodiments.

In an exemplary embodiment, the sensor processor 118D and the one or more corresponding sensor modules 108D can be implemented on a same or different integrated circuit within the communication platform 232. For example, the sensor processor 118D and corresponding sensor module 108D can be implemented in an integrated circuit that is different from, or the same as, the integrated circuit in which the communication module 102, host processor 104 and sensor hub 206 have been implemented. That is, although FIG. 2C shows these components within the communication platform 232, the components can be implemented on two or more different integrated circuits, including a first integrated circuit having communication module 102, host processor 104 and sensor hub 206; and a second integrated circuit having sensor processor 118D and corresponding sensor module 108D. Further, it should be appreciated that the various components of the communication platform 232 can be implemented in various combinations of different integrated circuits within the communication platform 232. For example, the communication module 102, host processor 104, sensor hub 206, and sensor processor 118D can be implemented on a first integrated circuit while the one or more sensor modules 108D can be implemented on a second integrated circuit.

The sensor hub 206, one or more sensor processors 118D and one or more sensor modules 108D can be similarly configured to perform the various operations and functions discussed above with respect to the sensor hub 110, sensor processor 118, and sensor modules 108. For example, the sensor hub 206 can be configured to request relativity information by querying one or more sensors of the sensor modules 108, pre-process and/or process the relativity information before providing such information to the host processor 104, communication module 102, and/or display 106, perform cross-sensor functionality with two or more sensors of the sensor module 108D, one or more sensors from one or more of the sensor modules 108A-C, or any combination thereof, and/or manage and/or coordinate the operation of the various communication platforms 204, to provide some examples. It should be appreciated that the configurations and operations of the above exemplary embodiments can also be implemented in the communication platform 200C.

Exemplary Communication Device with Two or More Communication Platforms

FIG. 2D illustrates a block diagram of a communication platform 200D according to an exemplary embodiment of the present disclosure. Communication platform 200D integrates communication and sensing capabilities across multiple integrated communication platforms. The exemplary communication platform 200D includes a first communication platform 232 that is integrated with one or more other communication platforms 204.

Communication platform 200D shares many common elements and features with communication platforms 100A, 100B, 200A-C of FIGS. 1A-2C, respectively. Some of all of the description of these repeated elements and features are not repeated here for brevity.

Similarly to the communication platforms 202, 230 and 232 of FIGS. 2A-C, respectively, the communication platform 234 includes communication module 102, host processor 104, display 106, communication interfaces 112A-C, sensor hub 206 (which may include communication module 212). The communication platforms 204A-C each include a communication module 210, sensor processor 118, and sensor module 108.

In an exemplary embodiment, the communication platform 234 also includes a communication module 210D, which is communicatively coupled to a respective sensor processor 118D via communication interface 216D. The sensor processor 118D is further communicatively coupled to one or more sensor modules 108D via communication interface 114D. The communication module 210D, sensor processor 118D and one or more sensor modules 108D can form a communication platform 204D similar to the communication platforms 204A-C. The communication module 210D is communicatively coupled to the sensor hub 206 via communication interface 224. The communication interface 224 is similar to the communication interfaces 222 and 114, and routes various communications between the sensor hub 206 and the communication module 210D. The sensor hub 206 can also be configured to be communicatively coupled via communication module 212 (e.g., wired and/or wirelessly) to one or more senor modules 108 included in one or more corresponding communication platforms 204A-C. Although not shown in FIG. 2D, the sensor module 108D and/or the sensor processor 118D can also be communicatively coupled directly to the sensor hub 206 via respective communication interfaces similar to the exemplary embodiments illustrated in FIGS. 2B and 2C.

In an exemplary embodiment, the communication platform 234 also includes a second sensor module that is communicatively coupled to the sensor hub 206 similarly to the configuration of the sensor module 108D illustrated in FIG. 2B. It should be appreciated that the second sensor module can be configured to implement the functions and operations of sensor module 108D of FIG. 2B as well as the various functions and operations of the above exemplary embodiments. Similarly, the communication platform 234 can also include another sensor processors communicatively coupled to the sensor hub 206, where the other sensor processor includes a third sensor module similar to the embodiment illustrated in FIG. 2C. It should be appreciated that the other sensor processor and the third sensor module can be configured to implement the functions and operations of sensor processors 118D and sensor module 108D of FIG. 2C, respectively, as well as the various functions and operations of the of the above exemplary embodiments.

In an exemplary embodiment, the communication module 210D, sensor processor 118D and the one or more corresponding sensor modules 108D can be implemented on the same integrated circuit, or different integrated circuits within the communication platform 234. For example, the sensor processor 118D and corresponding sensor module 108D can be implemented on an integrated circuit that is different from, or the same as, the integrated circuit in which the communication module 102, host processor 104 and sensor hub 206 have been implemented. That is, although FIG. 2D shows these components within the communication platform 234, the components can be implemented on two or more different integrated circuits. For example, the communication module 102, host processor 104 and sensor hub 206 can be implemented on a first integrated circuit; and the sensor processor 118D and corresponding sensor module 108D can be implemented on a second integrated circuit. Further, it should be appreciated that the various components of the communication platform 234 can be implemented in various combinations of different integrated circuits within the communication platform 234.

The sensor hub 206, communication module 210D, one or more sensor processors 118D and one or more sensor modules 108D can be similarly configured to perform the various operations and functions discussed above with respect to the communication modules 210, sensor hub 110, sensor processor 118, and sensor modules 108. It should be appreciated that the configurations and operations of the above exemplary embodiments can also be implemented in the communication platform 200D.

### Exemplary Connections of Two or More Communication Platforms

FIGS. 2E and 2F illustrate exemplary integrations of the communication platform 200A of FIG. 2A. As discussed above, communication platform 200A integrates communication and sensing capabilities across multiple integrated communication platforms, including communication platform 202 and communication platforms 204A-C.

The communication platforms 204 can be communicatively coupled to the communication platform 202 via one or more wired and/or wireless interconnections 224 (FIG. 2E) or communication interfaces 226 (FIG. 2F).

The communication interfaces 224 and 226 are similar to the communication interfaces 112, 114, 216, 220, and 222, and routes various communications between the communication platform 202 and communication platforms 204. These communications can include various digital signals, such as one or more commands and/or data to provide some examples, various analog signals, such as direct current (DC) currents and/or voltages to provide some examples, or any combination thereof. The communication interface 216 can be implemented as a series of wired and/or wireless interconnections between the communication platform 202 and communication platforms 204.

The interconnections of the communication platform 202 and communication platforms 204 can be arranged to form a serial interface (FIG. 2E) to route communications between the communication platform 202 and communication platforms 204 in series, a parallel interface (FIG. 2F) to route communications between the communication platform 202 and communication platforms 204 in parallel, or any combination thereof.

Further, the communication platforms 204 can be configured to directly communicate with the communication platform 202 utilizing one or more well-known wireless communication protocols. Here, the communication module 210 of a respective communication platform 204 can communicate with the communication module 102 of the communication platform 202.

In an exemplary embodiment in which the communication platforms are wirelessly connected to the communication platform 202 utilizing a serial interface, the serial interface can be configured to extend the wireless range of the various communication platforms 204. For example, in the event that the communication platform 204B is located out of range of direct wireless communication with the communication module 212 of the sensor hub 206 and/or the communication module 102 of the communication platform 202, the communication platform 204B can communicate with the in-range communication platform 204A, which may communicate with the communication platform 202.

Although FIGS. 2E and 2F illustrate serial and parallel interfaces with respect to the exemplary embodiment illustrated in FIG. 2A, it should be appreciated that the serial and parallel interfaces can be implemented in the other exemplary embodiments discussed herein.

Exemplary Communication Device with Two or More Communication Platforms

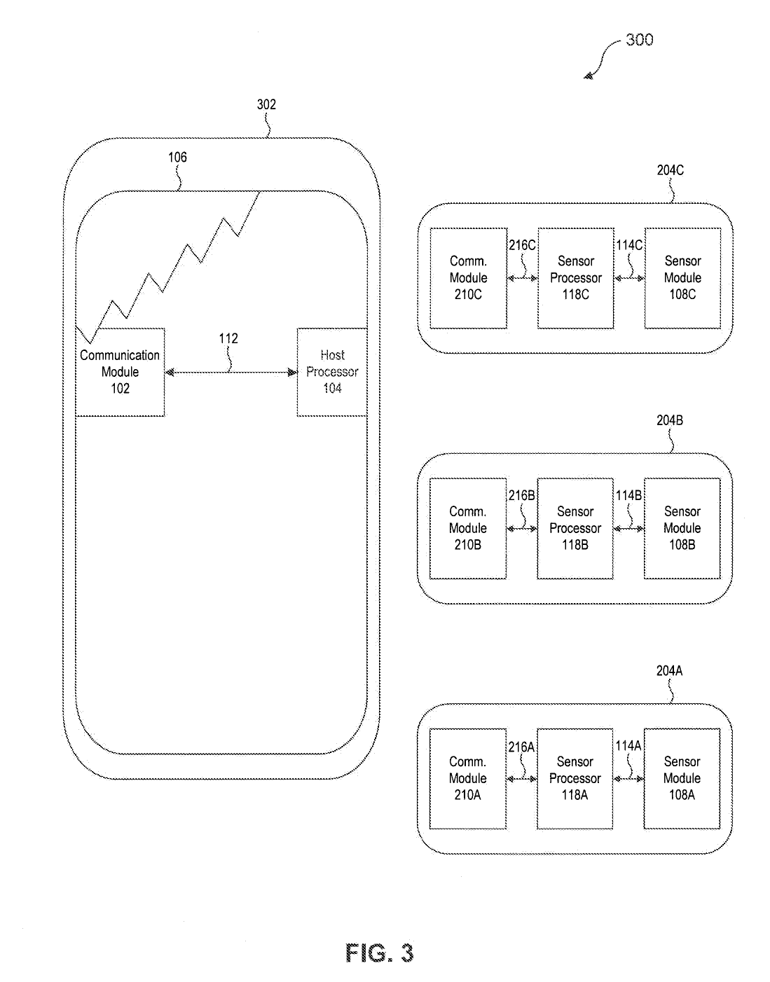

FIG. 3 illustrates a block diagram of a communication platform 300 according to an exemplary embodiment of the present disclosure. Communication platform 300 integrates communication and sensing capabilities across multiple integrated communication platforms. The exemplary communication platform 300 includes a first communication platform 302 that is integrated with one or more other communication platforms 204. Although FIG. 3 illustrates three communication platforms 204, one of ordinary skill in the relevant art(s) would understand that the various embodiments should not be limited to the three exemplary communication platforms 204, and the various exemplary embodiments can include a fewer or greater quantity of communication platforms 204.

The communication platform 302 communicates the information between the near-end user and the far-end user over various wired and/or wireless communication networks. The communication platform 302 can represent a mobile communication device, such as a cellular phone or a smartphone, a mobile computing device, such as a tablet computer or a laptop computer, or any other electronic device that is capable of communicating information that will be apparent to those skilled in the relevant art(s) without departing from the spirit and scope of the present disclosure.

The communication platforms 302 and 204 share many common elements and features with each other and with the exemplary communication platforms 100A, 100B, and 200A-F of FIGS. 1A, 1B, and 2A-F, respectively. In particular, the communication platform 302 is similar to the communication platforms 100A, 100B, 202, 230, 232, 234, and includes communication module 102, host processor 104, and display 106, and communication interface 112, and communication platforms 204A-C each include a communication module 210, sensor processor 118 and sensor module 108. Some or all of the description of these elements and features are not repeated here for brevity.

In an exemplary embodiment, the communication platform 302 does not include a sensor hub with one or more sensor modules as implemented in, for example, the communication platforms 202 and 230 discussed above. For example, the host processor 104 is configured to perform the processing of information received from one or more of the communication platforms 204, perform post processing on information that has been subjected to preprocessing by respective sensor processors 118 of the communication platforms 204, and/or processed information that has been subjected to processing by the respective sensor processors 118 of the communication platforms 204. That is, the host processor 104 can be configured to offload some or all of the processing operations to the various sensor processors 118 of the communication platforms 204.

In operation, the communication module 102 receives a request for relativity information from the host processor 104 via communication interface 112. The request for relativity information often includes one or more instructions that are communicated to the communication module 210 of the communication platforms 204 by the communication module 102. Upon receipt by the communication modules 210 of respective communication platforms 204, the instructions are provided to the respective sensor processors 118 which instruct the sensor processors 118 to query their respective sensor modules 108 for corresponding relativity information.

In some situations, the one or more instructions can include one or more commands that are selected from a common set of commands that is shared by and available to the communication module 102, the host processor 104, and the display 106 for accessing the corresponding relativity information and associated identifiers indicating a recipient of the corresponding relativity information. For example, the host processor 104 can select a corresponding command from the common set of commands to request temperature information from one or more of the sensor modules 108. In this example, the host processor 104 attaches a header having an identifier, as well as other information, to the corresponding command to form the request for relativity information. In this example, the host processor 104 thereafter provides the request for relativity information to the communication module 102 for transmission to one or more communication platforms 204. Also, in this example, the communication module 102 and/or the display 106 can also select the corresponding command from the common set of commands when requesting the temperature information; however, the communication module 102 and/or the display 106 can attach corresponding headers having corresponding identifiers to the corresponding command to form corresponding requests for relativity information.

As discussed above, one or more sensor processors 118 execute the one or more instructions within the request for relativity information to query the one or more sensor modules 108 of a corresponding one or more communication platforms 204 for the relativity information associated with the one or more instructions. This querying can include sampling of the relativity information that is continuously, or substantially continuously, provided by the sensor modules 108. This querying can additionally include activating one or more sensors within the sensor modules 108 to provide the relativity information associated with the one or more instructions. In some situations, the sensor processor 118 can directly query a corresponding sensor module 108 for the relativity information at predetermined instances in time. For example, the one or more instructions can cause the sensor processor 118 to query the sensor module 108 for the relativity information at a given instance in time and can cause the sensor processor 118 to query the sensor module 108 at future instances in time for the relativity information.

In an exemplary embodiment, the sensor processors 118 can pre-process the relativity information before providing the relativity information to the host processor 104, communication module 102, and/or display 106. Typically, the sensor processors 118 can load and/or execute one or more pre-processing functions that are stored within a memory that is accessible with the sensor processor 118. These pre-processing functions can include interrupt handling, polling, sampling, decimating, interpolating, algorithmic processing, auto-calibration, stabilizing, time-stamping, compressing, and/or formatting to provide some examples. For example, the sensor processors 118 can format the relativity information into a format that is suitable for use by the communication module 102, communication module 210, host processor 104, and/or display 106. This is most commonly achieved by converting the relativity information from a representation in an analog signal domain to a representation in a digital signal domain and, optionally, packetizing the digital signal domain representation of the relativity information into data packets for transport to the communication module 102, host processor 104, and/cm display 106.

The sensor processors 118 can also be configured to process the relative information independent of the host processor 104 by performing one or more computational intensive processing operations generally performed by the host processor 104. That is, the sensor processors 118 can be configured to control the operation and/or configuration of respective sensor modules 108 independent of the host processor 104. Here, the sensor processors 118 can be configured to provide the processed information in response to requests for such information by the communication module 102, the host processor 104, and/or the display 106.

In an exemplary embodiment, the pre-processing and/or processing operations to be performed by a sensor processor 118 can be fragmented and distributed to one or more other sensor processors 118 of respective other communication platforms 204. The various sensor processors 118 can then cooperatively pre-process and/or process the information, which is then communicated to the communication platform 302.

In an exemplary embodiment, the sensor processors 118 can be configured to perform cross-sensor functionality so as to utilize relativity information from a first sensor from among a respective sensor module(s) 108 to query a second sensor from the same sensor module 108, or from a different sensor module 108 of the same communication platform 204, and/or from a different sensor module 108 of a different communication platform 204, for its relativity information. Here, the cross-sensor functionality can be implemented in one or more of the pre-processing operations and/or processing operations performed by the sensor processors 118. For example, the sensor processors 118 can determine whether respective communication platforms 204 are in motion from location information provided by the first sensor of respective sensor module(s) 108 and can query a second sensor of the sensor module 108 (and/or a different sensor module 108 of the same communication platform 204) to provide platform user information when it is determined that the communication platform 204 is moving. Further, the sensor processors 118 can be configured to issue instructions to the communication module 102, the host processor 104, and/or the display 106, based upon the relativity information. For example, the sensor processors 118 can determine whether respective communication platform 204 are in motion from location information provided by the sensor module(s) 108 and can issue an instruction to the host processor 104 to enter into an active state, referred to as a wake up, from an inactive state, also referred to as a sleep state.

Similarly, in an exemplary embodiment in which two or more sensor modules 108 are communicatively coupled to a sensor processor 118, the sensor processor 118 can be configured to perform cross-sensor functionality so as to utilize relativity information from a first sensor of a first sensor module 108 to query a second sensor of a second sensor module 108. Similarly, the sensor processors 118 can be configured to perform cross-sensor functionality so as to utilize relativity information from a first sensor of a sensor module 108 of a first communication platform 204 to query a second sensor of a sensor module 108 of a second communication platform 204.

In an exemplary embodiment, a sensor processor 118 can be configured to manage and/or coordinate the operation of the various other communication platforms 204. For example, the sensor processor 118A can manage and/or coordinate the operational state (e.g., active/inactive) of its respective communication platform and one or more other communication platforms 204, the frequency at which relativity information is provided to the communication module 102 from the communication platforms 204, the wired and/or wireless protocols to be utilized for communication between respective communication platforms 204 and between the communication platforms 204 and the communication platform 202, or any other operation and/or function of the various communication platforms 204 as will be apparent to those skilled in the relevant art(s).

Similarly, in an exemplary embodiment, the management and/or coordination performed by the sensor hub 206 can be partially or entirely offloaded to one or more corresponding sensor processors 118 of the various communication platforms 204. Therefore, in exemplary embodiments where the sensor hub 206 offloads management and/or coordination operations to the one or more of the sensor processors 118, power consumption of the communication platform 202 can be reduced.

The communication platforms 204 and 302, and their respective components, can be similarly configured to perform the various operations and functions discussed above with respect to the communication platforms 100A, 100B, 202, 230, 232, and 234 as well as the various operations and functions of their respective components. That is, it should be appreciated that the configurations and operations of the above exemplary embodiments can also be implemented in the communication platform 300. It should further be appreciated that one or more of the operations and functions performed by the communication platforms 204 and 302 of the communication platform 300 can be performed by one or more components of the communication platforms 100A, 100B, 202, 230, 232, and 234 discussed above.

### Exemplary Operations of the Exemplary Communication Devices

The exemplary communication platforms 100A through the exemplary communication platform 300 can utilize the relativity information to supplement their configuration. For example, the exemplary communication platform 100A through the exemplary communication platform 300 can utilize the location information to supplement configuration of the communications module 102 to communicate the information between the near-end user and the far-end user over various wired and/or wireless communication networks. In an exemplary embodiment, the communication modules 102, communication modules 212 and/or communication modules 210, can include an antenna array having multiple antennas to communicate the information. For example, the antenna array can for part of Multiple Input Multiple Output (MIMO) configuration. In this example, location and/or gyroscopic information collected by one or more sensors 108 can be used to select one of the multiple antennas that perform better than other non-selected antennas given the relative location and/or orientation of the exemplary communication platforms 100A, 100B, 202, 230, 232, and/or 234 within their respective environment. Similarly, location and/or gyroscopic information can be used to calculate angles of arrival for beam forming purposes in a MIMO configuration given the relative location and/or orientation of the exemplary communication platforms 100A, 100B, 202, 230, 232, and/or 234 within their respective environment.

As another example, the exemplary communication platform 100A through the exemplary communication platform 300 can utilize the location information to configure the communication modules 102, communication modules 212 communication modules 210, sensor processors 118 and/or host processors 104 to scan for cells in a cellular communication network, WiFi network or the like. This is advantageous when movement is possible or likely. In this example, the scanning for the cells can be disabled when the location information provided by the sensor module 108 indicates that the exemplary communication platform 100 through the exemplary communication platform 300A is not in motion or has moved a distance less than a predetermined threshold distance. In this example, a frequency at which the exemplary communication platform 100 through the exemplary communication platform 300A scan for the cells can be adjusted by comparing location information at different instances in time, so that as movement increases/decreases so does the scanning for cells.

The exemplary communication platform 100 through the exemplary communication platform 300A can utilize the relativity information to supplement determinations of other modules within these communication platforms. For example, the exemplary communication platform 100 through the exemplary communication platform 300A can utilize the location information from, for example, a GNSS sensor as well as received signal strength information (RSSI) or round trip time (RTT) from the communication modules 102, communication modules 212 and/or communication modules 210 to better estimate distance between one of these communication platforms and another communication device and/or wireless access point. For example, the exemplary communication platform 100 through the exemplary communication platform 300A can typically determine a coarse location of this other communication device and/or wireless access point using the RSSI of signals provided by this other communication device and/or wireless access point. In this example, the exemplary communication platform 100 through the exemplary communication platform 300A can refine this coarse location to a more precise and/or accurate fine location using the location information. The exemplary communication platforms 100-300A can also determine a location of this other communication device and/or wireless access point using the RTT of signals provided by this other communication device and/or wireless access point.

As another example, the exemplary communication platform 200A through the exemplary communication platform 300 can be configured to offload processing, operational control and/or management operations to one or more external communication platforms 204. The offloading operation can be based on the operational power of the communication platforms 200A through 300 and/or of the one or more external communication platforms 204, the power supply capacity (e.g., battery capacity) of the communication platforms 200A through 300 and/or of the one or more external communication platforms 204, and/or the processing capacity of the communication platforms 200A through 300 and/or of the one or more external communication platforms 204 (e.g., the combined processing capacity of multiple communication platforms 204 cooperatively processing information may exceed the processing capacity of the communication platforms 200A through 300), to provide some examples.

For example, a communication platform 204 may be implemented in a vehicle, which can, for the purpose of this discussion, be considered a device having near limitless power supply capacity when compared to a mobile communication device (e.g., smartphone). In this example, the mobile communication device (e.g., communication platforms 202, or the like) may offload a portion or all of its processing operations to the vehicle (e.g., to sensor processor 118 and/or the processor of the vehicle computer system) and/or query relativity information from one or more sensors of the vehicle (e.g., position data from the vehicle's GNSS sensor) to reduce the power consumption of the mobile communication device.

### CONCLUSION

The aforementioned description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventors, and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

What is claimed is:

1. A communication platform, comprising:
a host processor configured to perform a plurality of processing operations;
a communication module communicatively coupled to the host processor; and
a sensor hub communicatively coupled to the host processor, the communication module, and one or more sensor modules configured to provide relativity information to the sensor hub, wherein the host processor is configured to offload a first portion of the processing operations that are associated with the relativity information to the sensor hub, and wherein the sensor hub is configured to execute the first portion of processing operations using the relativity information.

2. The communication platform of claim 1, wherein the first portion of the processing operations offloaded by the host processor include one or more pre-processing operations performed on the relativity information received from the one or more sensor modules.

3. The communication platform of claim 2, wherein the one or more pre-processing operations include one of interrupt handling, polling, sampling, decimating, interpolating, time-stamping, compressing, or formatting.

4. The communication platform of claim 1, wherein each of the one or more sensor modules includes one or more sensors configured to sense the relativity information.

5. The communication platform of claim 1, wherein the relativity information comprises at least one of environmental information, location information, and platform user information.

6. The communication platform of claim 1, wherein the sensor hub has a lower operational power requirement than the host processor.

7. The communication platform of claim 1, wherein the sensor hub is configured to provide the relativity information to at least one of the host processor and the communication module.

8. The communication platform of claim 1, further comprising:
a sensor processor communicatively coupled to the sensor hub and to one or more additional sensor modules that are configured to provide additional relativity information to the sensor processor, wherein the sensor processor is configured to process the additional relativity information received from the one or more additional sensor modules and to provide the additional relativity information or the processed additional relativity information to the sensor hub.

9. The communication platform of claim 8, wherein the host processor is configured to offload a second portion of the processing operations that are associated with the additional relativity information to the sensor processor.

10. The communication platform of claim 9, wherein the first and second portions of processing operations offloaded by the host processor include one or more pre-processing operations to be executed by the sensor hub or sensor processor on the respective relativity information or additional relativity information received from the respective one or more sensor modules or from the one or more additional sensor modules.

11. The communication platform of claim 9, wherein the sensor processor has a lower operational power requirement than the host processor.

12. The communication platform of claim 11, wherein the sensor hub has a lower operational power requirement than the host processor and the sensor processor has a lower operational power requirement than the sensor hub.

13. A communication platform, comprising:
a host processor;
a communication module communicatively coupled to the host processor; and
a sensor hub communicatively coupled to the host processor, the communication module, and one or more other communication platforms that are configured to generate first relativity information, the sensor hub being configured to manage execution of one or more processing operations offloaded by the host processor and associated with the first relativity information.

14. The communication platform of claim 13, wherein the sensor hub is further configured to offload a portion of the one or more of processing operations to a first other communication platform of the one or more other communication platforms.

15. The communication platform of claim 14, wherein the sensor hub is configured to control the first other communication platform of the one or more other communication platforms so as to offload at least one processing operation of the portion of processing operations from the first other communication platform to a second other communication platform of the one or more other communication platforms.

16. The communication platform of claim 13, wherein the sensor hub is configured to control the operation of one or more of the other communication platforms.

17. The communication platform of claim 13, farther comprising a first sensor module directly connected to the sensor hub and configured to provide second relativity information to the sensor hub.

18. The communication platform of claim 17, further comprising a first sensor processor communicatively coupled to the sensor hub and a second sensor module configured to generate third relativity information and provide the third relativity information to the first sensor processor, wherein the first sensor processor is configured to process the third relativity information and to provide the third relativity information or the processed third relativity information to the sensor hub.

19. The communication platform of claim 18, wherein one of the other communication platforms includes a second sensor processor communicatively coupled to a corresponding third sensor module configured to provide the first relativity information, and wherein the second sensor processor is configured to process the first relativity information and to provide the first relativity information or the processed first relativity information to the sensor hub.

20. A communication system, comprising:
a first communication platform including:
a host processor;
a communication module communicatively coupled to the host processor;
a sensor hub communicatively coupled to the host processor, the communication module, and one or more first sensor modules configured to provide first relativity information to the sensor hub;
a first sensor processor communicatively coupled to the sensor hub and to one or more second sensor modules configured to provide second relativity information to the first sensor processor, wherein the first sensor processor is configured to provide the second relativity information to the sensor hub; and
a second communication platform including:
a second sensor processor; and
one or more third sensor modules communicatively coupled to the second sensor processor, the one or more third sensor modules configured to provide third relativity information to the second sensor processor, wherein the sensor hub is configured to manage execution of one or more processing operations offloaded by the host processor to the sensor hub, the management including offloading a first portion of the one or more processing operations associated with the second relativity information to the first sensor processor, and offloading a second portion of the one or more processing operations associated with the third relativity information to the second sensor processor.
